(19) United States
(12) Patent Application Publication
(10) Pub. No.: US 2026/0338213 A1
(43) Pub. Date: Oct. 29, 2026

(54) CONNECTOR FOR FASTENING A FIRST COMPONENT TO A SECOND COMPONENT, CONNECTOR ASSEMBLY, COMPONENT ASSEMBLY, COMPONENT CONNECTION AND USE OF A CONNECTOR

(71) Applicant: Festool GmbH, Wendlingen (DE)

(72) Inventors: Wolfgang Reines, Altdorf (DE); Timo Bayer, Tuebingen (DE)

(73) Assignee: Festool GmbH, Wendlingen (DE)

(21) Appl. No.: 19/490,102

(22) PCT Filed: Jun. 4, 2024
(86) PCT No.: PCT/EP2024/065357

§ 371 Date: Dec. 4, 2025

(30) Foreign Application Priority Data
Jun. 5, 2023 (DE) 10 2023 205 236.9

(51) Int. Cl. F16B 5/02; F16B 25/00

(52) U.S. Cl. CPC F16B 5/02; F16B 25/0015

(57) ABSTRACT

A connector (30) for fastening a first component (12) to a second component (20) is described. One of the first component (12) and second component (20) has a recess (14) for receiving the connector (30). The connector (30) comprises a base body (34), which is delimited by a base surface (36), a top surface (38) and a lateral surface (40). The lateral surface (40) defines a lateral outer contour of the connector. A depression (42) extends from the top surface (38). Furthermore, a guide channel (48) extends with a guide channel central axis (M) from the depression (42) to the lateral surface (40) of the base body (34). The guide channel central axis (M) is inclined relative to a base body axis (G) standing perpendicular to the base surface (36) and/or perpendicular to the top surface (38). In addition, a component assembly (58) is proposed, which comprises a component (12, 20) with a recess (14) open on one side (14) and a connector (30). Moreover, a component connection (10) is presented, which comprises the first component (12), the second component (20), a fastening means (60) and the connector (30). A use of the connector (30) is also described.

The invention relates to a connector for fastening a first component to a second component. One of the first and second component has a recess for receiving the connector. The connector comprises a base body, which is delimited by a base surface, a top surface and a lateral surface.

The invention also relates to a connector assembly with such a connector.

The invention further relates to a component assembly, which comprises a component with a recess open on one side and such a connector.

In addition, the invention relates to a component connection comprising a first component, a second component, a fastening means and a connector.

The invention also relates to a use of a connector.

Such connectors and connector assemblies, component assemblies and component connections made therewith are known from the prior art. In particular, they are used to connect components made of wood.

In this context, the aim is always to establish a stable mechanical component connection by means of the connector. At the same time, the connector should have a simple design and be easy to handle. There is a trade-off between the stable mechanical component connection, the connector with a simple design and the easy handling of the connector.

It is therefore the object of the present invention to resolve or at least mitigate this trade-off, i.e. to propose a connector that has a structurally simple design and is easy to handle, wherein stable mechanical component connections can be established by means of the connector.

The object is achieved by a connector for fastening a first component to a second component. One of the first and second component has a recess for receiving the connector. The connector comprises a base body, which is delimited by a base surface, a top surface and a lateral surface. The lateral surface defines a lateral outer contour of the connector. A depression extends from the top surface, and a guide channel extends with a guide channel central axis from the depression to the lateral surface of the base body. The guide channel central axis is inclined relative to a base body axis standing perpendicular to the base surface and/or perpendicular to the top surface. In this context, an inclined orientation refers to an orientation that is neither parallel nor perpendicular. The guide channel central axis is thus neither parallel nor perpendicular relative to the base surface and/or relative to the top surface either. It is understood that the base surface and top surface can run parallel to one another but do not have to. In the event that the base surface and top surface are arranged parallel to one another, the base body axis is perpendicular both to the base surface and the top surface. The guide channel is suitable for guiding and/or receiving at least in sections a fastening means or a tool, in particular a drill. The guide channel preferably has a circular cross-section. Such a connector, which substantially comprises a base body with a depression and a guide channel, has a structurally very simple design. This is, inter alia, because the lateral surface defines a lateral outer contour of the connector. The connector therefore has no elements projecting laterally from the base body, such as pins or studs. The fact that the lateral surface defines the lateral outer contour is to be understood as meaning that the entire lateral outer contour is determined by the lateral surface. In particular, the connector comprises only a single component. The fact that the guide channel extends from the depression and the guide channel central axis runs inclined relative to the base body axis means that both a fastening means and a tool can be easily inserted into the guide channel. The depression creates the freedom of movement required for this. In other words, the connector can be handled comparatively easily. Moreover, the inclined guide channel central axis has the effect that a stable mechanical component connection can be formed by means of the connector. For this purpose, a fastening means can be inserted into the guide channel at least in sections. The inclined arrangement of the guide channel central axis results in a comparatively large coupling region between the fastening means and the first component and between the fastening means and the second component.

In one variant, the base surface, top surface and lateral surface together define an outer contour of the connector. Such a connector has a particularly simple design.

An outer contour can also be understood in this context as an envelope contour, which envelops the connector. A lateral outer contour can accordingly be understood as a lateral envelope contour, which envelops the connector laterally, i.e. from the sides.

Due to the fact that the lateral surface defines a lateral outer contour of the connector, the connector has no elements that lie outside of an outer contour of the top surface in a view perpendicular to the top surface, i.e. protrude beyond the outer contour of the top surface. Accordingly, the outer contour of the top surface also defines a lateral outer contour or a lateral envelope contour of the connector in the view perpendicular to the top surface.

Alternatively or in addition to the inclination of the guide channel central axis relative to the base body axis standing perpendicular to the base surface and/or perpendicular to the top surface, the guide channel central axis can be inclined relative to the lateral surface at an intersection of the guide channel central axis and the lateral surface. It is understood that the intersection of the guide channel central axis and lateral surface is a virtual intersection. This is because the lateral surface is penetrated by the guide channel in the region of the intersection. The intersection is therefore not physically present, but exists only virtually. This results in the effects and advantages already explained.

The guide channel central axis is preferably inclined in the direction of the base surface at the intersection between the guide channel central axis and the lateral surface. This means that the intersection between the guide channel central axis and the lateral surface is closer to the base surface than points of the guide channel central axis that are closer to the depression starting from this intersection. This has the effect that the connector is pulled in the direction of a base of the recess of the first component or second component when the connector is arranged in the recess and using a fastening means arranged in the guide channel, the first component and second component are fastened to one another. In this way, the stability of the connection between the first component and second component is further increased.

According to one variant, at least one retaining means is arranged on the lateral surface and is designed to hold the connector in the recess of the first or second component. A plurality of retaining means are preferably arranged on the lateral surface. In this context, the retaining means can be designed as a retaining rib or groove. In the event that there are a plurality of retaining means, each of the retaining means is designed as a retaining rib or groove. The retaining ribs or grooves are used to clamp the base body of the connector to a lateral surface of the recess. Alternatively or in addition, the retaining means can be designed as a retaining fin. In the event that there are a plurality of retaining means, each of the retaining means is designed as a retaining fin. The retaining fins are used to clamp the base body of the connector to the lateral surface of the recess. In this context, the retaining fins can be elastically deformed, for example bent, when the connector is inserted into the recess of the first or second component. All variants have the effect that the connector is reliably held in the recess on the first or second component.

The guide channel can have a chamfer on its depression-side end, i.e. on that end of the guide channel that faces the depression. The chamfer preferably runs completely around a circumference of the guide channel. Such a chamfer makes it easier to insert a fastening means and/or tool into the guide channel. This makes the connector even easier to handle.

The base body can have the shape of a cylinder or the shape of a truncated pyramid or the shape of a truncated cone. In this context, a cylinder is understood as a general cylinder. The base body can therefore have a shape that results from shifting a flat, closed curve along a straight line. The straight line can be oriented arbitrarily with respect to the curve. In one special case, the straight line is perpendicular to a surface defined by the closed curve. In this special case, the cylinder is also referred to as a right circular cylinder. Similarly, in the variant in which the base body has the shape of a truncated pyramid, it can have a base surface of any shape. In on example, the base surface is quadrangular, for example rectangular or square. In another example, the base surface of the truncated pyramid is hexagonal. Even in the variant in which the base body has the shape of a truncated cone, the truncated cone have a base surface of any shape. Preferred examples are circular or elliptical base surfaces. In all variants, the base body has a structurally simple design. At the same time, a base body formed in this way can provide a comparatively large lateral surface, via which a retaining force can be transferred to the component that has the recess in which the connector is arranged. Connectors formed in this way are therefore used to establish a stable mechanical component connection.

An outer contour of the connector therefore preferably has the shape of a cylinder or the shape of a truncated pyramid or the shape of a truncated cone.

The guide channel central axis can form an angle of between 30 degrees and 85 degrees with the base body axis. This means that the guide channel central axis forms an angle of 5 degrees to 60 degrees with the base surface and top surface to which the main body axis is perpendicular. In one example, the guide channel central axis and the base body axis form an angle of 45 degrees. In another example, the guide channel central axis and the base body axis form an angle of 60 degrees. A guide channel central axis inclined in this way has the advantage that a fastening means and/or a tool can be conveniently inserted into the guide channel. Furthermore, as already mentioned, a stable mechanical connection is established, as a coupling region between the fastening means and the first component and/or second component is comparatively large due to the inclination.

The guide channel central axis is preferably inclined relative to the base body axis standing perpendicular to the base surface and/or perpendicular to the top surface and/or relative to the lateral surface in such a way that a notional extension of the guide channel which extends through the depression extending from the top surface does not intersect the base body. In other words, a projection of a cross-section of the guide channel, which occurs along the guide channel central axis in the direction of the depression extending from the top surface, does not touch or intersect the base body. In such a configuration, a fastening means and/or tool can be inserted into the guide channel in a particularly convenient manner.

The guide channel central axis is preferably inclined relative to the base body axis standing perpendicular to the base surface and/or perpendicular to the top surface and/or relative to the lateral surface in such a way that a notional extension of the guide channel along the guide channel central axis in the direction of the side of the connector opposite the guide channel, i.e. in the direction of the depression, only intersects the plane of the top surface of the connector. In this context, the plane of the top surface is delimited by an outer contour of the top surface. In this way, a fastening means can be mounted in a particularly simple manner when the connector is inserted into the recess for receiving the connector.

In one variant, the depression has a flat wall surface. The guide channel extends from the flat wall surface. In particular, the guide channel central axis stands perpendicular to the flat wall surface. Such a wall surface is simple in terms of structure and manufacturing technology. Furthermore, a flat wall surface is particularly suitable as a contact surface for a fastening means, which is arranged at least in sections in the guide channel. In one example where the fastening means is a screw, a screw head can be placed against the wall surface in this context. In this way, comparatively large forces can be transmitted between the connector and fastening means. This is useful for a stable mechanical component connection.

According to one embodiment, the depression has a varying depth measured along the base body axis. A deepest point of the depression lies adjacent to the guide channel. In other words, a depth of the depression is not constant. In particular along a direction, which corresponds to a continuation of the guide channel central axis projected into the depression. This direction can also be referred to as the longitudinal or lengthwise direction of the connector. Alternatively, this direction can be referred to as the longitudinal or lengthwise direction of the depression. Due to the fact that the depression constitutes a mechanical weakening of the base body, the varying depth means that the depth only ever needs to be as great as is necessary locally. Adjacent to the guide channel, a comparatively large depth can therefore be used to create the necessary freedom of movement for a fastening means or tool to be arranged in the guide channel. Anywhere else, a smaller depth may be sufficient in order to arrange the fastening means or tool in the guide channel. Overall, a stable mechanical connector can therefore be created, which is nevertheless easy to handle. The latter relates in particular to inserting the fastening means or tool into the guide channel.

According to another embodiment, the depression has a concavely curved depression base surface. In particular, the concavely curved depression base surfaces transitions smoothly into one or more side surfaces of the depression. The concavely curved depression base surface provides, on the one hand, the necessary freedom of movement within the depression for fastening means and/or tools which are to be inserted into the guide channel. On the other hand, the curvature is advantageous in terms of a force or stress distribution within the connector, as stress and force peaks are avoided in particular compared to an angular design. The mechanical stability of the connector is thus improved in this way.

The concavely curved depression base surface can be a section of a circular cylinder lateral surface, wherein a radius of the circular cylinder lateral surface is larger than a radius of the guide channel. Such a depression base surface has a simple structure and can be produced comparatively simply and cost-effectively using known manufacturing methods.

A central axis associated with the circular cylinder lateral surface is preferably aligned with the guide channel central axis. In other words, the guide channel and the section of the depression base surface designed as a circular cylinder lateral surface are arranged coaxially. This results in a comparatively simple structure of the connector.

In one exemplary embodiment, the base body has a length measured perpendicular to the base body axis and a width measured perpendicular to the base body axis and perpendicular to the length. The length and the width are the same size. Such a base body is comparatively compact.

The base surface and/or top surface can be circular or polygonal. One special case of polygonal is square. In this context, the term polygonal also includes polygon shapes where the corners of the polygon are rounded. The base surface and top surface preferably have the same shape. Overall, all variants have a connector with a structurally simple design.

The base body can also have a length measured perpendicular to the base body axis and a width measured perpendicular to the base body axis and perpendicular to the length, wherein the length is greater than the width. Such a base body is therefore elongated. In this way, comparatively large areas can be created for force transmission between the connector and the first component or second component, in whose recess the connector is inserted. The elongated shape also provides a certain space for the depression. The depression can therefore be designed in such a way that a fastening means and/or a tool can be inserted into the guide channel in a particularly convenient manner.

In one alternative embodiment, the guide channel extends from a narrow side of the lateral surface. A comparatively large space is thus provided for the depression.

In the event that the length of the base body is greater than the width, the base surface and/or the top surface can be polygonal or elliptical or composed of at least two geometric elements. One special case of polygonal is rectangular. In this context, the term polygonal also again includes polygon shapes where the corners of the polygon are rounded. In one example where the base surface and/or top surface is rectangular, a fillet radius of the rounded corners can, for example, correspond to half the width of the rectangle. In the event that the base surface and/or top surface is or are composed of at least two geometric elements, the base surface and/or top surface is or are, for example, composed of two or more intersecting circular areas, which respectively have their central point on a common alignment line. The base surface and top surface preferably have the same shape. Overall, all variants have a connector with a structurally simple design.

In addition, the object is achieved by a connector assembly, which comprises a connector according to the invention and a fastening means. The fastening means is arranged at least in sections in the guide channel. The fastening means is suitable for being coupled to the first component and/or to the second component. In this context, the fastening means can be loosely arranged in the guide channel or securely held in the guide channel. In the second mentioned alternative, a retention element can be provided, which is separate from the base body and fastening means. Alternatively, the guide channel can be tailored to the fastening means, for example in terms of its diameter, such that the fastening means is securely held. Further alternatively, a securing means can be provided within the guide channel, which is used to securely hold the fastening means. In all variants, thanks to the fact that the fastening means is arranged in the guide channel, the connector is suitable for connecting two components without any other elements.

In one example, the fastening means is a screw. Such fastening means have proven themselves in terms of their handling and mechanical stability. Furthermore, they can be operated using standard tools.

The object is further achieved by a component assembly, which comprises a component with a recess open on one side and a connector according to the invention. The connector is arranged in the recess. The shape of the recess corresponds to the shape of the base body of the connector such that a lateral surface of the base body and a lateral surface of the recess run adjacent to each other. Such a recess can also be referred to as a pocket or blind hole. The base surface of the connector preferably rests against a bottom surface of the recess. The top surface of the connector is preferably arranged flush with that side of the component in which the recess is arranged. The recess can, like the connector, have the shape of a cylinder, a truncated pyramid or a truncated cone. In the event that the recess has the shape of a truncated pyramid or a truncated cone, the recess narrows along its depth direction. It is understood that the recess must always be somewhat larger than the connector which is inserted therein. The recess is therefore structurally as simple as the connector. In addition, the connector can be easily inserted into the recess due to the corresponding shapes of the connector and recess.

The component can have a contact surface for contact with another component. The recess open on one side can be closed in a direction towards the contact surface. In other words, a section of the component is arranged between the recess and the contact surface. In the event that the component is connected to another component by means of the connector, this section lies between the connector and the other component. This section is therefore used for force transmission between the component and the connector. In other words, the connector can be reliably supported on this section. High forces can be transmitted. A stable mechanical connection can therefore be established.

Furthermore, the object is achieved by a component connection. The component connection comprises a first component, a second component, a fastening means and a connector according to the invention. The first component has a recess open on one side. The connector is arranged in the recess. The shape of the recess corresponds to the shape of the base body of the connector such that a lateral surface of the base body and a lateral surface of the recess run adjacent to each other. Furthermore, the fastening means is arranged at least in sections in the guide channel of the connector and engages with the second component. The fastening means can also engage with the first component, namely with that section of the first component which lies between the connector and the second component. Alternatively, a receiving channel can be provided for the fastening means in the region of the first component which lies between the connector and the second component, which receiving channel is arranged coaxially with the guide channel of the connector. In this case, the fastening means does not engage with the first component in such a way that it would directly transfer forces into a wall of the receiving channel or absorb forces from the wall of the receiving channel. In any case, a stable and reliable connection of the first component and second component results from the fact that the fastening means engages with the second component and is coupled to the first component via the connector. Moreover, such a component connection can be easily established due to the fact that both the connector and the recess for receiving the connector have a relatively simple design.

The first component and second component are preferably made of wood. The first component can therefore be a wooden component. The second component can also be a wooden component.

In one example, both the first component and second component are panels. The component connection can be designed as a corner joint or flat joint in this context.

The first component can have a first contact surface and the second component can have a second contact surface The first contact surface and the second contact surface can make contact with each other. The recess open on one side can be closed in a direction towards the first contact surface. In other words, a section of the first component is arranged between the recess and the second component. This section is therefore used for force transmission between the first component and the connector. In other words, the connector can be reliably supported on this section. High forces can be transmitted. A stable mechanical connection can therefore be established.

It is understood that a position at which the fastening means exits the first contact surface is determined, inter alia, by a distance between the connector and the first contact surface. This distance can be selected according to the specific application.

Moreover, it is understood that different types of fastening means can be used depending on the application. This concerns, for example, the length of the fastening means.

The fastening means is preferably designed as a screw. The fastening means is further preferably designed as a wood screw. In this context, an end of the wood screw opposite the screw head is designed to be pointed. Moreover, a screw core body of a wood screw, i.e. that longitudinal section of the screw on which an external thread is arranged, can have a conical or tapered section.

In addition, the object is achieved by a use of a connector according to the invention as a drilling template. In this context, the guide channel is used to guide a drill. The connector is first of all inserted into the recess of the first component and then the drill is guided in the guide channel. In this context, a receiving channel can be produced between the recess in which the connector is inserted and the first contact surface of the first component, through which the fastening means, for example the screw, can be inserted. Alternatively, only a core hole can be produced, which also extends between the connector and the first contact surface. The core hole differs from the receiving channel in that the core hole is designed in such a way that a force transmission takes place between a wall of the core hole and the fastening means. The use of the connector as a drilling template makes it particularly easy to produce a component connection, as no separate drilling template has to be provided unlike known methods.

A component connection according to the invention can thus be produced by a first component, a second component and a connector being provided in a first step. A recess may already be present for the connector in the first component or this recess can be produced during the course of the first step. Then, in a second step, the connector is inserted into the recess. In an optional third step, the connector can be used as a drilling template. This means that a drill is guided in the guide channel of the connector in order to produce a hole in the first component. As already explained above, this hole can be designed as a core hole or as a receiving channel. Then, in a fourth step, a fastening means, such as a screw, can be inserted into the guide channel and connected to the second component and/or first component. It is understood that the first component and second component must be in contact with each other via the respective contact surfaces. In the event that the fastening means is a screw or another fastening means operated by means of a tool, an appropriate tool can also be inserted at least in sections into the recess in order to connect the fastening means to the second component and/or first component so that it interacts with the fastening means within the recess. A screwdriver or hex key can be used in this context, for example.

Furthermore, the features, effects, and advantages mentioned in connection with one out of the connector according to the invention, the connector assembly according to the invention, the component assembly according to the invention, the component connection according to the invention, and the use according to the invention likewise apply to each of the other out of the connector according to the invention, connector assembly according to the invention, component assembly according to the invention, component connection according to the invention, and use according to the invention. The aforementioned examples and variants can therefore be combined, regardless of whether they are mentioned in connection with the connector according to the invention, the connector assembly according to the invention, the component assembly according to the invention, the component connection according to the invention or the use according to the invention.

The invention is explained below based on various exemplary embodiments, which are shown in the appended drawings. In the drawings:

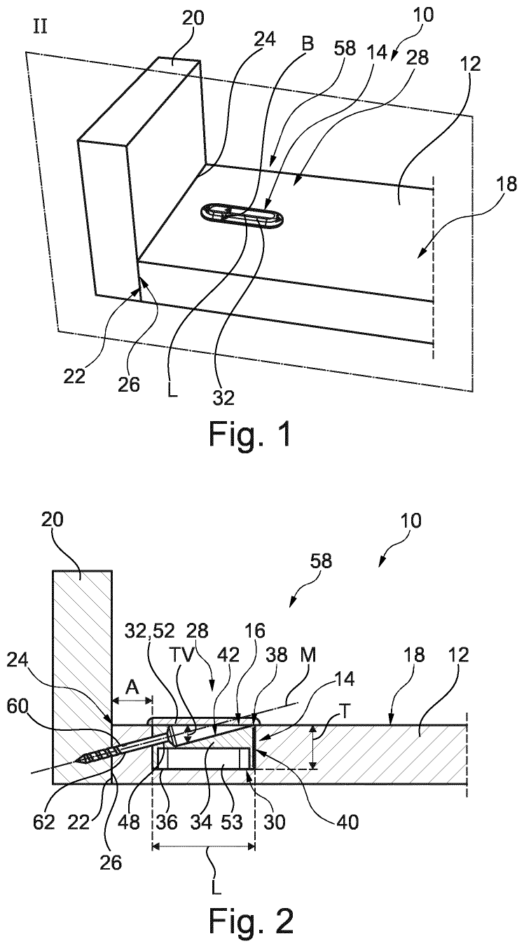

FIG. 1 shows a component connection according to the invention with a component assembly according to the invention and a connector according to the invention in a perspective view,

FIG. 2 shows the component connection shown in FIG. 1 in a sectional view along the plane II,

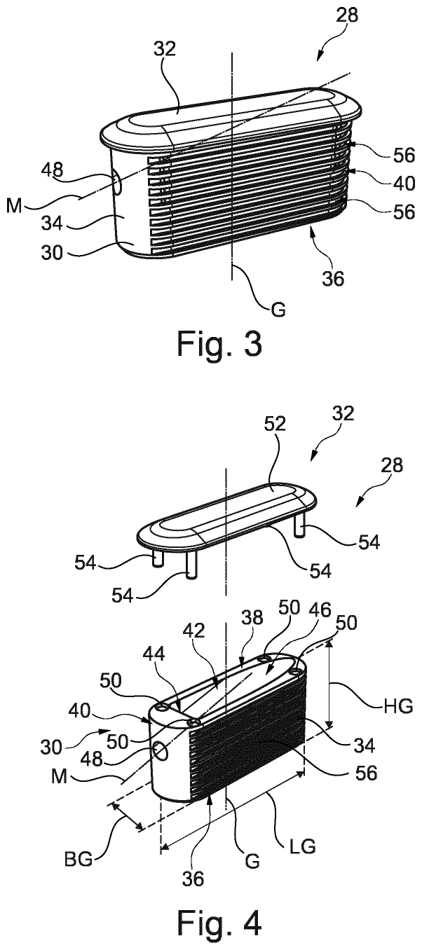

FIG. 3 shows the connector shown in FIGS. 1 and 2 in a separate view,

FIG. 4 shows the connector shown in FIG. 3 in an exploded view, as viewed from a first perspective,

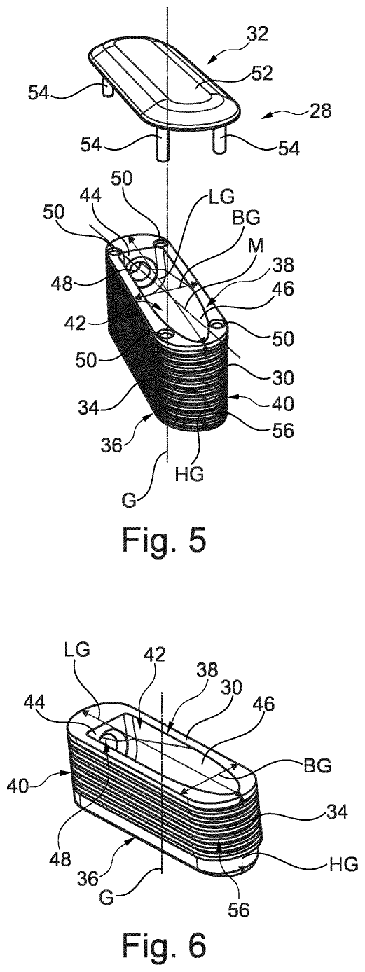

FIG. 5 shows the connector shown in FIG. 3 in an exploded view, as viewed from a second perspective,

FIG. 6 shows a connector according to the invention in accordance with another embodiment, which can be used alternatively in the component connection according to FIGS. 1 and 2,

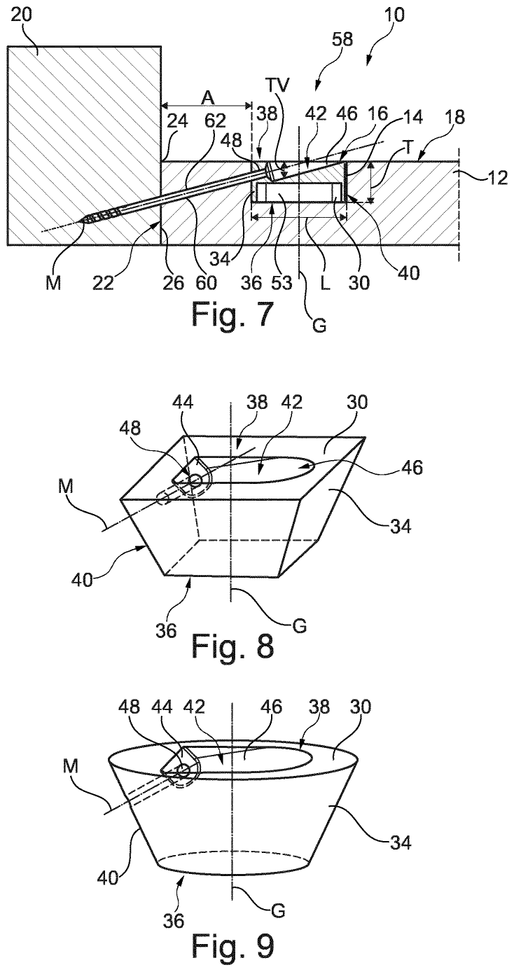

FIG. 7 shows an alternative embodiment of the component connection shown in FIGS. 1 and 2 in a view corresponding to FIG. 2,

FIG. 8 shows a connector according to the invention in accordance with a further embodiment, which can be used alternatively in the component connection according to FIGS. 1 and 2,

FIG. 9 shows a connector according to the invention in accordance with another embodiment, which can be used alternatively in the component connection according to FIGS. 1 and 2, and

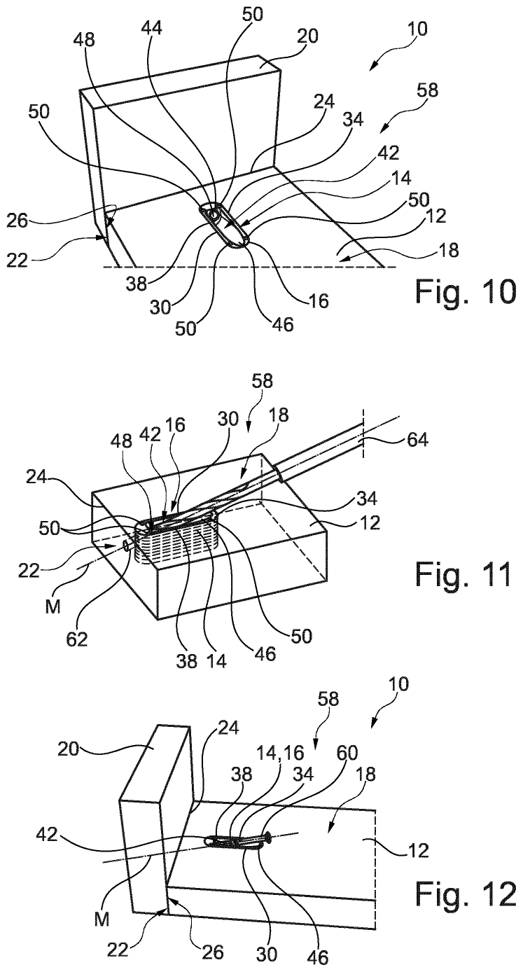

FIGS. 10 to 12 show selected intermediate steps when producing the component connection shown in FIGS. 1 and 2.

FIGS. 1 and 2 show a component connection 10, which is designed as a right-angled corner joint in the embodiment shown.

The component connection 10 comprises a first component 12. In the embodiment shown, the first component 12 is plate-shaped.

The first component 12 is made of wood.

Furthermore, the first component comprises a recess 14 open on one side.

In the embodiment shown, an opening 16 delimiting the recess 14 open on one side is provided on a flat side 18 of the first component 12.

The opening 16 has a cross-section, which has the shape of a rectangle with rounded corners. A corner radius corresponds to half the width of the rectangle.

In this context, a longitudinal direction of the opening 16, with runs along the greater extension of the opening, coincides with a longitudinal direction L of the recess 14.

A width direction of the opening 16, which runs perpendicular to the longitudinal direction of the opening 16 and thus runs along the smaller extension of the opening 16, coincides with a width direction B of the recess 14.

A depth direction T of the recess 14 runs perpendicular to the longitudinal direction L and to the width direction B (see FIG. 2).

The cross-section of the recess 14 is constant along the depth direction T.

The recess 14 consequently has the shape of an elongated hole, which is designed as a blind hole. Alternatively, the recess 14 can be referred to as a milled pocket with no undercut.

Moreover, the component connection 10 comprises a second component 20.

The second component 20 is also plate-shaped in the embodiment shown.

The second component 20 is also made of wood.

In the present case, the second component 20 does not have a recess.

The first component 12 and second component 20 are in contact with one another.

More specifically, the first component has a first contact surface 22, which runs substantially at a right angle to the flat side 18 of the first component 12. The first contact surface 22 and the flat side 18 are delimited by a common edge 24.

The recess 14 open on one side is therefore further closed in the direction of the first contact surface 22.

The second component 20 has a second contact surface 26.

The first contact surface 22 and the second contact surface 26 make contact with each other.

Since the first contact surface 22 has a smaller area than the second contact surface 26 in the present exemplary embodiment, the second contact surface 26 is in full contact with the first contact surface 22 in the example shown, whereas the first contact surface 22 is only in contact with a section of the second contact surface 26.

The component connection 10 further comprises a connector assembly 28, which is shown in detail in FIGS. 3 to 5.

The connector assembly 28 has a connector 30 and a cap 32.

The connector 30 has a base body 34, which has the shape of a general cylinder and is delimited by a base surface 36, a top surface 38 and a lateral surface 40.

In the embodiment shown, the shape of the base body 34 is a right circular cylinder. A base body axis G is thus perpendicular to the base surface 36 and perpendicular to the top surface 38.

Furthermore, the base surface 36 is polygonal. More specifically, the base surface 36 has the shape of a rectangle with rounded corners. A corner radius corresponds to half the width of the rectangle.

The top surface 38 has the same shape as the base surface 36, also being polygonal.

The top surface 38 defines an upper outer contour or upper envelope contour of the connector 30.

The base surface 36 defines a lower outer contour or lower envelope contour of the connector 30.

The lateral surface 40 defines a lateral outer contour or lateral envelope contour of the connector 30.

Accordingly, the base surface 36, top surface 38 and lateral surface together define an outer contour or envelope contour of the connector 30.

The base body 34 has a length LG measured perpendicular to the base body axis G. The length of the base body corresponds to the longer extension of the polygonal base surface 36 and polygonal top surface 38.

Furthermore, the base body 34 has a width BG measured perpendicular to the base body axis G and perpendicular to the length LG. The direction of the width BG thus corresponds to the shorter extension of the polygonal base surface 36 and polygonal top surface 38.

Due to the fact that the polygonal base surface 36 and polygonal top surface 38 have the shape of a rectangle, the length LG of the base body 34 is greater than the width LG of the base body 34.

A height HG of the base body 34 is measured along the base body axis G.

The base body 34 also has a depression 42, which extends from the top surface 38.

The depression 42 is elongated and extends substantially along the direction of the length LG of the base body 34.

The depression 42 has a flat wall surface 44.

The flat wall surface 44 delimits the depression 42 on a narrow side.

Furthermore, the narrow side is inclined relative to the base body axis G, wherein, for this, the flat wall surface 44 is rotated about an axis running parallel to the width direction of the base body 34.

This means that a normal to the flat wall surface 44 intersects the base body axis G. However, the normal and the base body axis G are not oriented perpendicular to one another.

Furthermore, the depression 42 is delimited by a concavely curved depression base surface 46.

In the exemplary embodiment shown, the concavely curved depression base surface 46 is designed as a section of a circular cylinder lateral surface.

A central axis belonging to the section of this circular cylinder lateral surface is perpendicular to the flat wall surface 44.

The concavely curved depression base surface 46 extends such that the depression 42 has a varying depth TV measured along the base body axis G (see FIG. 2).

More specifically, the depth TV of the depression 42 is zero at an end of the depression 42 facing away from the flat wall surface 44. A deepest point of the depression 42 thus lies adjacent to the flat wall surface 44.

Moreover, the base body has a guide channel 48, which extends from the flat wall surface 44 and extends up to the lateral surface 40.

The guide channel 48 thus extends from a narrow side of the lateral surface 40.

The guide channel 48 has a constant, circular cross-section in this case.

The guide channel 48 has a guide channel central axis M, which is oriented perpendicular to the flat wall surface 44.

The guide channel central axis M is thus inclined relative to the base body axis G.

In the exemplary embodiment shown, an angle formed by the guide channel central axis M and the base body axis G is 70 degrees.

Since the lateral surface 40 runs perpendicular to the base surface 36 and perpendicular to the top surface 38, i.e. parallel to the base body axis G, an angle formed by the guide channel central axis M and the lateral surface 40 is also 70 degrees. This refers to the intersection between the guide channel central axis M and the lateral surface 40.

The guide channel central axis M is inclined in the direction of the base surface 36. This means that the intersection between the guide channel central axis M and the lateral surface 40 is closer to the base surface 36 than points of the guide channel central axis M that are closer to the depression 42 starting from this intersection.

The central axis, which is associated with the circular cylinder lateral surface, and the guide channel central axis M coincide.

A radius of the circular cylinder lateral surface, i.e. a radius of the concavely curved depression base surface 46 is, however, greater than a radius of the guide channel 48.

Furthermore, a total of four retaining holes 50 are arranged in the top surface 38. One of the retaining holes 50 is positioned in each case in the area of a corner of the polygonal top surface 38.

All four retaining holes 50 are designed as blind holes. The retaining holes 50 are used to hold the cap 32 on the connector 30.

The cap 32 accordingly comprises a substantially plate-shaped cover element 52, from which a total of four retaining pins 54 project.

The plate-shaped cover element 52 has substantially the shape shape as the top surface 38 and base surface 36. The cover element 52 is therefore also polygonal, wherein it is designed as a rectangle with rounded corners in the embodiment shown.

A width of the cover element 52 is selected such that it is slightly greater than the width BG of the connector 30. A length of the cover element 52 is also selected such that it is slightly greater than the length of the connector 30.

In a state where the cap 32 is fitted to the connector 30 by virtue of the fact that each of the retaining pins 54 is inserted into an associated retaining hole 50, the cover element 52 thus protrudes from the connector 30 on all sides (see in particular FIG. 3).

The base body 34 further has a cavity 53, which extends from the base surface 36. The recess 53 serves to reduce the amount of material required to manufacture the connector.

In the present case, the connector is made of a plastic material.

In the embodiment shown, the connector 30 is arranged in the recess 14 of the first component 12 open on one side.

The shape and size of the recess 14 and connector 30 are matched to each other in such a way that the base surface 36 of the connector 30 rests against a bottom of the recess 14. The top surface 38 of the connector is arranged substantially flush with the flat side 18 of the first component 12.

Furthermore, the lateral surface 40 of the connector 30 rests substantially against a lateral surface of the recess 14 open on one side. In other words, the lateral surface 40 of the connector 30 and the lateral surface of the recess 14 open on one side run adjacent to each other.

In order to securely hold the connector 30 in the recess 14, a section of the lateral surface 40 has grooves 56. Only one single exemplary groove 56 has a reference numeral in the figures for the sake of clarity.

The combination of the first component 12 and connector 30, which is arranged in the recess 14 open on one side, can also be referred to as the component assembly 58.

The component connection 10 also comprises a fastening means 60 (see in particular FIG. 2).

The combination of connector 30 and fastening means 60 can also be referred to as connector assembly.

In the embodiment in accordance with FIGS. 1 to 5, the fastening means 60 is a self-tapping screw.

The screw is screwed into the second component 30 with a pointed section. In other words, the pointed section of the screw or more generally, the fastening means 60, engages with the second component. A head of the fastening means 60 arranged opposite the point of the fastening means 60 rests against the flat wall surface 44.

A central section located between the head and the point of the fastening means 60 is arranged partially in the guide channel 48 and partially in a receiving channel coaxially adjoining the guide channel. In the present case, the receiving channel is designed as a through-hole 62 in the first component 12.

The fastening means 60, here the screw, is therefore screwed into the second component 20 in such a way that the head, in this case the screw head, rests against the flat wall surface 44 under tension and thereby applies force to the connector 30 in the direction of an end of the recess 14 open on one side which faces the second component 20. As a result, a section of the first component 12, which lies between the connector 30 and the second component 20, is clamped between the connector 30 and the second component 20.

FIG. 6 shows a connector 30 according to an alternative embodiment. Only the difference compared to the connector 30 according to the embodiment shown in FIGS. 1 to 5 will be discussed below.

This difference consists of the fact that the connector shown in FIG. 6 does not have retaining holes 50. A cap 32 cannot therefore be arranged on the connector 30 according to FIG. 6.

Otherwise, the connector according to FIG. 6 corresponds to the connector that was explained with reference to FIGS. 1 to 5. The above statements apply accordingly.

FIG. 7 shows a component connection 10 according to another embodiment. Only the differences compared to the component connection shown in FIGS. 1 and 2 will be discussed.

In the component connection according to FIG. 7, a distance A between the recess 14 of the first component 12 open on one side and the first contact surface 22 of the first component 12 is greater than in the component connection 10 according to FIGS. 1 and 2.

Accordingly, the component connection 10 according to FIG. 7 comprises a fastening means 60, which is once again designed here as a self-tapping screw, which is substantially longer than the fastening means 60 of the component connection shown in FIGS. 1 and 2.

It is understood that the fastening means 60 must always be selected to be long enough that it can engage with the second component 20 over a desired length when it is arranged in the guide channel 48 and through-hole 62 in such a way that the head of the fastening means 60 rests against the flat wall surface 44.

Another difference of the component connection 10 according to FIG. 7 compared to the component connection 10 according to FIGS. 1 and 2 is that in the component connection 10 according to FIG. 7, the connector 30 according to FIG. 6 is used. Accordingly, the component connection 10 according to FIG. 7 does not have a cap 32.

The connectors 30 from the embodiments described above, more specifically the base bodies 34 of the connectors 30, respectively have a height HG of 12 mm. A length LG is 33 mm and a width BG is 10 mm.

These dimensions are selected such that the associated recess 14 open on one side can be produced with little effort using a so-called dowel milling machine. In particular, an associated recess can be produced without having to move the dowel milling machine relative to the first component 12. This means that the dowel milling machine only has to be positioned on the first component 12 once in order to be able to mill an associated recess 14 open on one side. A milling cutter is used with a diameter that corresponds to the width BG of the base body 34, i.e. in the present case has a diameter of 10 mm.

Alternative dimensions of the connector 30 and associated recess 14 are listed in the following table, wherein the specified dimensions always belong together line by line.

| | | |
|---|---|---|
| BG | LG | HG |

| | | | |
|---|---|---|---|
| 5 | mm | 25 mm | 12 mm |
| 6 | mm | 27 mm | 12 mm |
| 8 | mm | 30 mm | 12 mm |
| 10 | mm | 33 mm | 12 mm |
| 12 | mm | 36 mm | 12 mm |
| 14 | mm | 39 mm | 12 mm |

In this context, all dimensions specified for the connector 30 or recess 14 open on one side should be understood as nominal dimensions. With suitable tolerancing, application-specific combinations of connectors 30 and recesses 14 can be created on the basis of these nominal dimensions, which form an interference fit, a clearance fit or a transition fit. It is also possible in this context to select the tolerance so that the connector 30 can be used for a plurality of applications. In other words, the tolerance can also be provided independently of the application.

Of course, connectors 30 and associated recesses 14 can also have dimensions that are smaller than the dimensions specified in the above table or larger than the dimensions found in the above table. A ratio of the width BG to the length LG of the base body 34 of the connector 30 is preferably in the range of 0.25 to 0.35. A preferred ratio is 0.3. The height HG can be 12 mm as standard. The height HG is therefore independent of the application. Alternatively, the height HG can be selected in an application-specific manner.

FIG. 8 shows a connector 30 according to another embodiment.

Again, only the differences with the aforementioned connectors 30 will be discussed.

The connector shown in FIG. 8 has a base body 34, which has the shape of a truncated pyramid.

Accordingly, as before, although the base surface 36 and top surface 38 of the connector 30 are oriented parallel to one another, the base surface 36 is considerably smaller than the top surface 38.

As before, the guide channel central axis M is inclined relative to the base body axis G standing perpendicular to the base surface 36 and perpendicular to the top surface 38, for example by 70 degrees. In addition, the guide channel central axis M is, as in the aforementioned embodiments, inclined in the direction of the base surface 36.

In the embodiment according to FIG. 8, however, the lateral surface 40 does not run parallel to the base body axis G. This applies to all side surfaces of the truncated pyramid-shaped base body 34, which together form the lateral surface 40.

Accordingly, an inclination of the guide channel central axis M relative to that section of the lateral surface 40 through which it passes differs from the inclination of the guide channel central axis M relative to the base body axis G.

Alternatively, the guide channel central axis M can also be perpendicular to that section of the lateral surface 40 through which it passes. The guide channel central axis M can thus also have no inclination relative to this section of the lateral surface 40. This variant is shown in FIG. 8.

Moreover, the connector according to FIG. 8 has no grooves 56 on its lateral surface 40.

It is understood that in a component connection 10, in which the connector according to FIG. 8 is used, the recess 14 open on one side must be adapted to the geometry of the connector 30. Accordingly, the recess 14 must also have the shape of a truncated pyramid.

The recess 14 is preferably dimensioned in such a way that the base surface 36 of the connector 30 makes contact with a bottom surface of the recess 14 when the connector 30 is inserted into the recess 14.

It is further preferable that the top surface 38 of the connector 30 runs flush with the flat side 18 of the first component 12 when the connector 30 is inserted into the recess 14.

Furthermore, in this state, the lateral surface 40 of the connector 30 and the lateral surface of the recess 14 preferably run adjacent to each other.

A connector 30 according to another embodiment is shown in FIG. 9.

Again, only the differences with the aforementioned connectors 30 will be discussed.

The connector shown in FIG. 9 has a base body 34, which has the shape of a truncated cone.

Accordingly, as before, although the base surface 36 and top surface 38 of the connector 30 are oriented parallel to one another, the base surface 36 is considerably smaller than the top surface 38.

Furthermore, both the base surface 36 and the top surface 38 are circular.

As before, the guide channel central axis M is inclined relative to the base body axis G standing perpendicular to the base surface 36 and perpendicular to the top surface 38, for example by 70 degrees. In addition, the guide channel central axis M is, as in the aforementioned embodiments, inclined in the direction of the base surface 36.

In the embodiment according to FIG. 9, however, the lateral surface 40 does not run parallel to the base body axis G.

Accordingly, an inclination of the guide channel central axis M relative to the lateral surface 40 differs from the inclination of the guide channel central axis M relative to the base body axis G. Reference is made to an intersection between the guide channel central axis M and the lateral surface 40 when determining the inclination of the guide channel central axis M relative to the lateral surface 40.

Alternatively, the guide channel central axis M can, at the intersection between the guide channel central axis M and the lateral surface 40, also be perpendicular to the lateral surface 40. The guide channel central axis M can thus also have no inclination relative to the lateral surface 40. This variant is shown in FIG. 9.

Moreover, the connector according to FIG. 9 has no grooves 56 on its lateral surface 40.

It is understood that in a component connection 10, in which the connector according to FIG. 9 is used, the recess 14 open on one side must be adapted to the geometry of the connector 30. Accordingly, the recess 14 must also have the shape of a truncated cone.

The recess 14 is preferably dimensioned in such a way that the base surface 36 of the connector 30 makes contact with a bottom surface of the recess 14 when the connector 30 is inserted into the recess 14.

It is further preferable that the top surface 38 of the connector 30 runs flush with the flat side 18 of the first component 12 when the connector 30 is inserted into the recess 14.

Furthermore, in this state, the lateral surface 40 of the connector 30 and the lateral surface of the recess 14 preferably run adjacent to each other.

A method for producing a component connection 10 is explained below with reference to FIGS. 10 to 12.

In order to produce such a component connection 10, a first component 12 with a one-sided recess 14 and a second component 20 are provided. Furthermore, a connector 30 is provided, which is the same connector in FIGS. 10 to 12 by way of example as in FIGS. 1 to 5.

In the present case, it is assumed that the recess 14 is already present in the first component 12. If this is not the case, it must first of all be produced.

The connector 30 can then be inserted into the recess 14 open on one side.

As already mentioned, this takes place in such a way that a base surface 36 of the connector 30 makes contact with a bottom surface of the recess 14 and the top surface 38 of the connector 30 runs flush with the flat side 18 of the first component 12. In this state, the lateral surface 40 of the connector 30 and the lateral surface of the recess 14 run adjacent to each other (see FIG. 10).

The connector 30 is then used as a drilling template. This means that a drilling tool 64 is inserted into the guide channel 48 and, guided by the guide channel 48, the through-hole 62 is produced in the first component 12, which connects the recess 14 to the first contact surface 22 (see FIG. 11).

In the present example, a through-hole 62 is produced for the fastening means 60. This means that the through-hole 62 is dimensioned such that the fastening means 60 can be pushed through the through-hole 62 substantially without resistance.

In one alternative embodiment, instead of the through-hole 62, a core hole can be produced. The core hole is characterised in that the fastening means 60, which is designed as a screw in this case, can only engage through the core hole by rotating, i.e. by utilising the thread. It is therefore not possible to push the fastening means axially through the core-hole.

In this alternative too, the connector 30 can be used as a drilling template. Compared to the aforementioned alternative, only a drilling tool 64 with a smaller diameter needs to be used.

If the through-hole 62 is produced, the fastening means 62, in this case the screw, can be inserted into the guide channel 48 and into the through-hole 62. Furthermore, the second component 20 must then be placed against the first contact surface 22 with the second contact surface 26 (see FIG. 12).

Now the fastening means 60, which is a self-tapping screw in this case, can be screwed into the second component 20.

For this, a screwdriver engages with the head of the fastening means 60.

Furthermore, the fastening means 60 is guided through the guide channel 48 when screwed into the second component 20. The screwdriver can initially engage with the head of the fastening means 60 outside of the depression 42. However, in particular shortly before the component connection 10 is produced, the head of the fastening means 60 is arranged at least partially within the depression 42 such that the engagement of the screwdriver with the head of the fastening means 60 also takes place at least in sections within the depression.

If the fastening means 60 engages with the second component 20 in such a way that a head of the fastening means 60 rests against the flat wall surface 44 under tension and thus applies force to the connector 30 and the first component 12 in the direction of the second contact surface 26, the cap 32 can be optionally placed onto the connector 30.

For this, the retaining pins 54 are inserted into the associated retaining holes 50.

### REFERENCE LIST

10 component connection
12 first component
14 recess
16 opening
18 flat side
20 second component
22 first contact surface
24 edge
26 second contact surface
28 connector assembly
30 connector
32 cap
34 base body
36 base surface
38 top surface
40 lateral surface
42 depression
44 wall surface
46 depression base surface
48 guide channel
50 retaining hole
52 cover element
53 cavity
54 retaining pin
56 groove
58 component assembly
60 fastening means
62 through-hole
64 drilling tool
A distance
B width direction of the recess
BG width of the base body
G base body axis
HG height of the base body
L longitudinal direction of the recess
LG length of the base body
M guide channel central axis
T depth direction of the recess
TV depth of the depression

1. A connector for fastening a first component to a second component, wherein one of the first component and second component has a recess for receiving the connector, the connector comprising:
a base body, which is delimited by a base surface,
a top surface, and
a lateral surface,
wherein the lateral surface defines a lateral outer contour of the connector,
wherein a depression extends from the top surface, and a guide channel extends with a guide channel central axis (M) from the depression to the lateral surface of the base body, and
wherein the guide channel central axis (M) is inclined relative to a base body axis (G) standing perpendicular to the base surface and/or perpendicular to the top surface.

2. The connector according to claim 1, wherein the base body has the shape of a cylinder or the shape of a truncated pyramid or the shape of a truncated cone.

3. The connector according to claim 1, wherein the guide channel central axis (M) forms an angle of between 30 degrees and 85 degrees with the base body axis (G).

4. The connector according to claim 1, wherein the depression has a flat wall surface and the guide channel extends from the flat wall surface.

5. The connector according to claim 1, wherein the depression has a varying depth (TV) measured along the base body axis (G) and a deepest point of the depression lies adjacent to the guide channel.

6. The connector according to claim 1, wherein the depression has a concavely curved depression base surface.

7. The connector according to claim 6, wherein the concavely curved depression base surface is a section of a circular cylinder lateral surface, wherein a radius of the circular cylinder lateral surface is larger than a radius of the guide channel.

8. The connector according to claim 7, wherein a central axis associated with the circular cylinder lateral surface is aligned with the guide channel central axis (M).

9. The connector according to claim 1, wherein the base body has a length (LG) measured perpendicular to the base body axis (G) and a width (BG) measured perpendicular to the base body axis (G) and perpendicular to the length (LG), wherein the length (LG) and the width (BG) are the same size.

10. The connector according to claim 9, wherein the base surface and/or the top surface are circular or polygonal, wherein polygonal also includes polygon shapes where the corners of the polygon are rounded.

11. The connector according to claim 1, wherein the base body has a length (LG) measured perpendicular to the base body axis (G) and a width (BG) measured perpendicular to the base body axis (G) and perpendicular to the length (LG), wherein the length (LG) is greater than the width (BG).

12. The connector according to claim 11, wherein the guide channel extends from a narrow side of the lateral surface.

13. The connector according to claim 11, wherein the base surface and/or the top surface are polygonal or elliptical or composed of at least two geometric elements, wherein polygonal also includes polygon shapes where the corners of the polygon are rounded.

14. A connector assembly, comprising:
a connector according to claim 1, and
a fastener, wherein the fastener is arranged at least in sections in the guide channel of the connector.

15. A component assembly, comprising:
a component with a recess open on one side, and
a connector according to claim 1, which is arranged in the recess,
wherein the shape of the recess corresponds to the shape of the base body of the connector such that a lateral surface of the base body and a lateral surface of the recess run adjacent to each other.

16. The component assembly according to claim 15, wherein the component has a contact surface for contact with another component and wherein the recess open on one side is closed in a direction towards the contact surface.

17. A component connection, comprising:
a first component,
a second component,
a fastener, and
a connector according to claim 1,
wherein the first component has a recess open on one side,
wherein the connector is arranged in the recess,
wherein the shape of the recess corresponds to the shape of the base body of the connector such that a lateral surface of the base body and a lateral surface of the recess run adjacent to each other, and
wherein the fastener is arranged at least in sections in the guide channel of the connector and engages with the second component.

18. The component connection according to claim 17, wherein the first component has a first contact surface, wherein the second component has a second contact surface, wherein the first contact surface and the second contact surface make contact with each other, and wherein the recess open on one side is closed in a direction towards the first contact surface.

19. A drilling template, comprising:
a connector according to claim 1.

20. A connector for fastening a first component to a second component, wherein one of the first component and second component has a recess open on one side for receiving the connector, wherein the recess is closed in a direction towards a contact surface, the connector comprising:
a base body, which is delimited by a base surface,
a top surface, and
a lateral surface, wherein the lateral surface defines a lateral outer contour of the connector so that in a state in which the connector is arranged in the recess, the lateral surface of the base body and a lateral surface of the recess run adjacent to each other, wherein a depression extends from the top surface, and a guide channel extends with a guide channel central axis (M) from the depression to the lateral surface of the base body, and wherein the guide channel central axis (M) is inclined relative to a base body axis (G) standing perpendicular to the base surface and/or perpendicular to the top surface.
